(19) United States
(12) Patent Application Publication
(10) Pub. No.: US 2008/0075631 A1
(43) Pub. Date: Mar. 27, 2008

(54) DISPOSABLE APPARATUS FOR SAMPLE EVALUATION

(76) Inventor: Xuehui Liu, Orefield, PA (US)

Correspondence Address: LARSON AND LARSON, 11199 69TH STREET NORTH, LARGO, FL, 33773, US

(21) Appl. No.: 11/534,033

(22) Filed: Sep. 21, 2006

(51) Int. Cl. G01N 31/22

(52) U.S. Cl. 422/58

(57) ABSTRACT

A disposable apparatus for testing a liquid specimen is disclosed including an enclosure made from paper (or cardboard); the paper coated on at least one side with a water resistant coating and at least one test strip is interfaced to the enclosure. The test strip is housed within the enclosure, outside the enclosure or extends from the enclosure. The entire apparatus is disposable without disassembly.

### FIELD OF THE INVENTION

This invention relates to an apparatus for evaluating test samples and more particularly, for an apparatus made from a material that is biodegradable for evaluating liquid test samples.

### BACKGROUND OF THE INVENTION

Various membrane-based diagnostic devices have been used to accept liquid biological samples, evaluate the sample and display test results by color change such as detecting AIDS, pregnancy, drug abuse, bacteria, viruses and the like. The simplest of such are single test strips that have a chemical that, after dipped in a liquid sample, undergoes a biochemical reaction when exposed to the target substance. These test strips are limited in the number of tests that can be performed at one time, are limited with regards to privacy and create a disposal issue. If a series of tests need be performed, multiple test strips are exposed to the same sample, creating a potential for confusion between the different tests and requiring disposal or storage of multiple strips. If the strips have to be retained for evidence or transported to another location, they need to be sealed in a container to prevent contamination and prevent exposure to potentially biologically hazardous materials.

The simplest tester is a membrane-based assay that provides visual evidence of the presence of a target analyte in a liquid sample. These testers include freestanding dipstick devices or devices enclosed within plastic housings. An example of such is a home pregnancy tester. To use such a device, a liquid sample such as urine, blood or saliva, is dropped into the sample collection area or the device is dipped into the liquid sample. After a pre-determined time period, the result appears as a change in color (in a window if the device has an enclosure). Testers usually have two color-change agents, one acting as a control indicating the test is working properly and the other indicating the presence of the associated pathogen/target. Usually the target is an antigenic and the color change element is formed by a sandwich of an antibody, antigen and antibody. The first antibody is pre-coated on a solid phase of a nitrocellulose membrane and the other is conjugated onto colloidal gold dried on the strip. If the target antigenic protein exists in the liquid specimen, it binds to both antibodies and, because of the red color of the colloidal gold, the test area shows a reddish color. In some types of testers, the color-change works differently, in that, the test line does not show the color if the target exists in the sample.

After use, these devices become a disposal issue being that they are made from materials that do not decompose. The enclosure or handles, made from plastic, do not decompose in landfills and, being made from plastic, emit harmful gasses when incinerated. Used testers make their way into the environment and create issues to wildlife. Furthermore, environmental regulations in many countries create a demand for significant improvements to these test devices. These regulations are so stringent that, in Europe and Japan, the plastic carrier or cassette must be separated from its contents and each must be disposed separately using two different methods or reduction. In devices that protect the patient's confidentiality, such confidentiality is breached when the plastic carrier is opened. Additionally, the extra steps consume valuable time; add to the expense of testing; and the person who disassembles the plastic carrier can be exposed to potentially hazardous biological waste if proper precautions are not taken.

An example of such a device is described in U.S. Pat. No. 6,150,178 to Cesarczyk et al, which is hereby incorporated by reference. This patent describes a specimen collecting and testing device that slides out of a plastic holder by pushing a shaft, passing the test membrane and exposing it to the sample. The described device is limited to one particular test. Furthermore, once the sample is collected, there is no seal to prevent leakage if this device is to be stored or transported to another location. The plastic holder is an example of the issue discussed previously—it does not decompose and emits toxic gasses when incinerated.

What is needed is an apparatus for specimen collecting that provides for a single or multiple tests that is made from a material that enables efficient disposal and reduction.

### SUMMARY OF THE INVENTION

Accordingly, an objective of the present invention is to provide a specimen tester that performs single or multiple tests from a sample and is made from a common material that is biodegradable.

Another objective of the present invention is to provide a specimen tester that has a substrate made from paper, thereby enabling environmentally friendly disposal and reduction methods.

In a first embodiment, a disposable apparatus for testing a specimen is disclosed including an enclosure made from a stiff paper, the stiff paper (or cardboard) coated on at least one side with a water resistant coating and at least one test strip interfaced to the enclosure.

In another embodiment, a method for collecting and testing a specimen using a disposable tester is disclosed including providing a tester. The tester includes an enclosure made from a stiff paper coated with a water resistant coating and at least one test strip interfaced to the enclosure. The method continues with exposing the at least one test strip at an exposure point to the specimen and reading the results from an indicator window.

In another embodiment, a disposable apparatus for collecting and testing a liquid specimen is disclosed including an enclosure made from paper and coated with a water resistant coating and at least one test strip interfaced to the enclosure.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of the device of the present invention.

FIG. 2 illustrates a bottom perspective view of the device of the present invention.

FIG. 3 illustrates a side perspective view of the device of the present invention.

FIG. 4 illustrates a perspective view of a second embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

The present invention is directed towards a sample evaluation kit fabricated from an environmentally friendly material that withstands the rigor of the testing environment while providing efficient disposal mechanisms. In the prior art, such testers are made from one or more test strips made from a material such as cellulose, nitrocellulose and paper; and are enclosed in a housing usually made from plastic. Although cellulose is generally environmentally friendly, the plastic housing is not. The plastic is often an ethylene polymer or the like, made from petroleum or a natural gas extraction. The fabrication of these materials itself is a strain on the environment, not to mention disposal and reduction issues including harmful gasses emitted when the plastic housing is reduced by burning. The term “reducing” refers to rendering the device harmless to the environment. Reducing includes burning/incinerating, compacting, composting and being allowed to decompose in a landfill. Throughout this specification, the terms test strip, test membrane and test wick are used to describe a device that accepts a liquid sample and, if a pre-determined substance is present in the sample, a color shows up or a color disappears. The various types of test strips, test membranes and test wicks are interchangeable with regards to the specification and claims.

The present invention includes a test device that is made from a paper substrate. In one embodiment, the paper substrate is for example 450 g white cardboard. Other paper weights are used depending upon the applications such as 200 g, 12-ply, 9-point and 110 lbs. For the purpose of the present invention, the term paper is equivalent to cardboard, stiff paper or tag board. The test strip and carrier are, in some embodiments, made from the same material or a synergistic material thereby eliminating any need to disassemble a plastic housing, as in the prior art, to separate the test strip(s) from the housing for reduction. The inventive steps of the present invention include coating the paper with a water-resistant coating providing protection from the samples being taken while enabling many modes of reduction including composting and incineration. One such water-resistant coating is made from a mixture of gelatin, Xanthan and alum, a mixture often used to coat ordinary playing cards. Such a coating is non-toxic and provides resistance to liquids for several hours so that the test device does not decompose rapidly when exposed to the liquid specimen. Otherwise, if uncoated paper were to be used, the housing would become flimsy and not retain its original shape. Being coated by a non-toxic material, the entire tester can be disposed without disassembly. Additionally, the entire tester can be incinerated without producing toxic gasses.

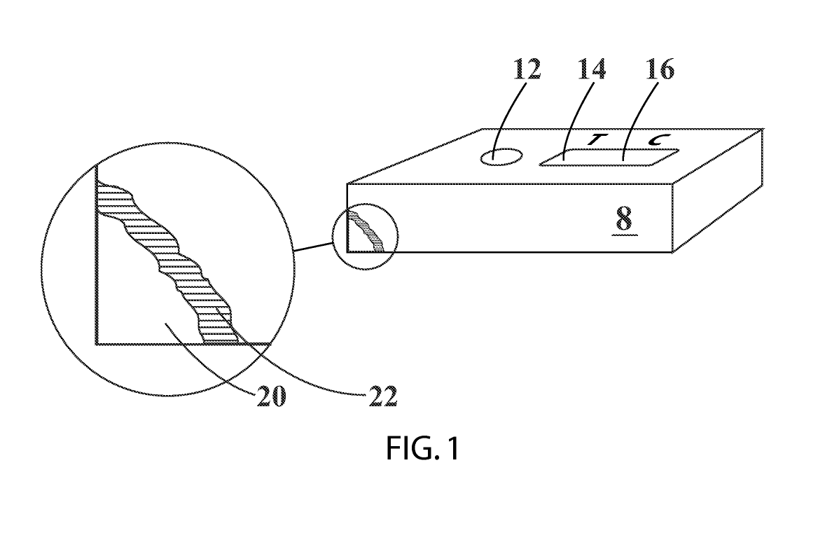

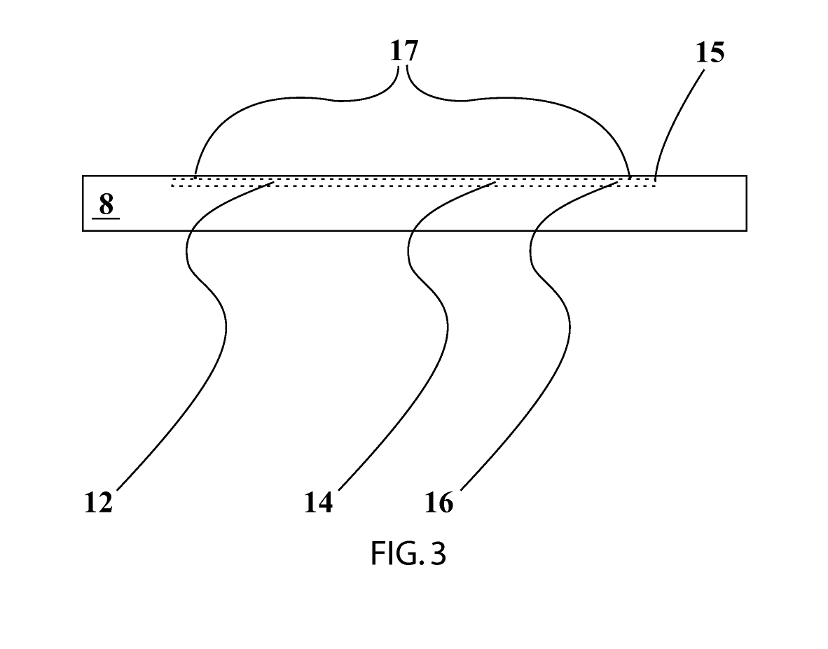

Referring to FIG. 1, a perspective view of the device of the present invention is shown. In this embodiment, the tester 8 is of rectangular shape, but in other embodiments, the tester is, for example, of square, circular, hexagonal, octagonal, pentagonal or triangular shape as the overall shape is exemplary. The tester 8 has an enclosure made from a paper substrate 22 coated with a water resistant coating 20. A test strip (see FIG. 3, 15) is housed within the enclosure 8 and a sample window 12 provides a location on which a liquid sample is deposited. One or more indicator windows 14/16 provide visibility of the indicator area of the test strip 15. The test strip 15 and enclosure 8 are preferably made from the same substrate material thereby eliminating any need to disassemble the enclosure to separate the test strip(s) 15 from the housing during reduction. The paper substrate 22 of the enclosure 8 is preferably coated 20 with a mixture of gelatin, Xanthan and alum, a mixture often used to coat ordinary playing cards. The coating 20 is preferably non-toxic and provides resistance to liquids for a period of time, preferably remaining water resistant for several hours so that the test device does not decompose when exposed to the liquid specimen. Being composed of a paper base, the entire tester can be incinerated without producing toxic gasses. In some embodiments, the inside of the enclosure is also coated with the same coating (not shown). An example of such coating is described in U.S. Pat. No. 4,762,702 to Gerhard, et al. and is hereby incorporated by reference. This patent describes a coating for ibuprofen that comprises a hydro-colloid. The described coating makes the tablet or caplet water resistant for a short period of time, thereby protecting the esophagus and gastrointestinal tract from irritation. The hydro-colloid in this example preferably comprises xanthan gum and/or maltodextrin. A similar coating can be applied to the enclosure 8. In some embodiments, the test strip 15 include a filter layer and a drying layer, as known in the industry.

In some embodiments, the test strip 15 comprises a hydrophilic microporous membrane that is treated with an agent that reacts to the presence of specific matter in the test specimen by changing color. For example, a test strip 15 is sprayed with an anti-hCG antibody that changes color upon exposure to the b-hCG in a sample from a pregnant woman. When exposed to a sample containing b-hCG that specific test strip changes color. Many types of test strip are known in the industry and the present invention is not limited to any particular test, chemical compound or test membrane construction. For an example, several test membranes are disclosed in U.S. Pat. No. 6,150,178 to Cesarczyk and Phildius.

In some embodiments, the test strip (s) 15 are obstructed from view, preventing the technician who obtained the sample from seeing the results. In this embodiment, the tester is transferred to another person for evaluation, whereby the obstruction is defeated. In some embodiments, the obstruction is a layer of opaque security tape. In some embodiments, the obstruction is part of the tester and a mechanical operation must be performed to obtain access to the results.

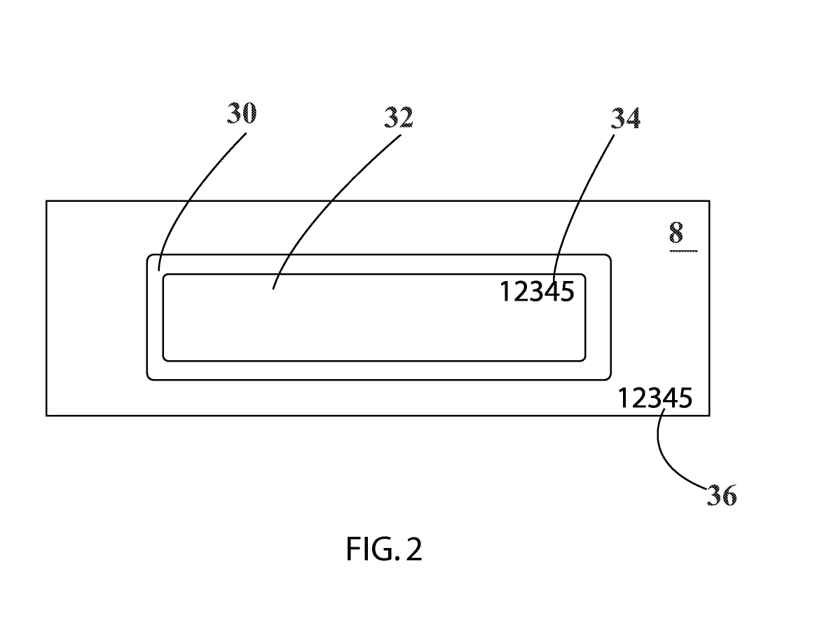

Referring to FIG. 2, a bottom perspective view of the device of the present invention is shown. In some embodiments, an identification label 32 is provided on an outside surface of the enclosure 8. The identification label 32 lets the technician write notes on the enclosure 8. In some embodiments, the identification label 32 is a peel-off label having a permanent portion 30 that adheres to the enclosure 8 and a removable portion 32 that can be removed and, for example, affixed to a patient's medical chart or record. The removable portion 32 preferably has an adhesive backing to stick to the patient's medical chart or record. In some embodiments, the permanent portion 30 is treated with a carbonless copy coating so that writing on the removable label 32 transfers onto the permanent label 30. In some embodiments, a serial number or similar code 34 is printed on the removable label 32 and a matching code 36 is printed on the enclosure to enable matching of the removable label 32 to the tester 8 after they are separated. In this example, the serial number 34/36 is a series of numerical digits while in other embodiments, the serial number 34/36 is alphanumeric or a bar code or other matching system.

Referring to FIG. 3, a perspective side view of the device of the present invention is shown. The enclosure 8 has a test strip 15 affixed to its top inner surface in the vicinity of the sample window 12 and indicator window(s) 14/16. The strip 15 is affixed to the inside surface of the enclosure 8 in a way known in the industry. For example, the strip 15 can be glued to the inside surface of the enclosure 8 as shown by glue points 17. In some embodiments, the test strip 15 includes an absorption pad 12 that is coupled to the indicator pad 16 by capillary action of a nitrocellulose strip (not shown). In this example, the indicator pad is a gold conjugate pad. Other test strips can be used without veering from the present invention.

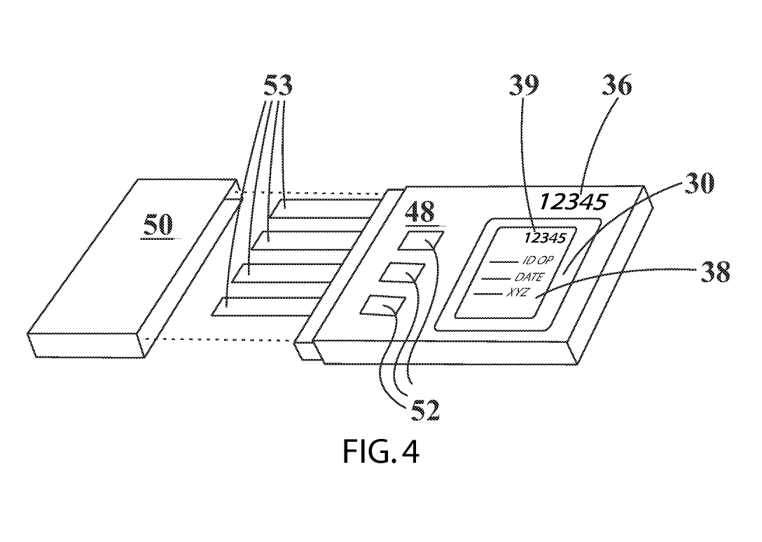

Referring to FIG. 4, a perspective view of a second device of the present invention is shown. In this embodiment, the tester includes a base unit 48 and a cover 50. The base unit 48 houses multiple test wicks 53, each having an indicator window 52. The cover 50 preferably interfaces tightly to the base unit 48, covering the test wicks 53 before and after a sample is taken. To use this tester, the cover 50 is removed and the ends of the test wicks are dipped into the specimen. Afterwards, the cover 50 is replaced and the results visible in the indicator windows 52. The cover 50 and base unit 48 are made from a paper substrate as in the previous embodiment and are coated with a water resistant coating. In some embodiments, more than one indicator window 48 (only one is shown) is provided for each of the test membranes 53. The test wicks 53, cover 50 and base unit 48 are preferably made from the same substrate material thereby eliminating any need to disassemble the enclosure to separate the test membrane(s) 53 from the housing. The paper substrate of the cover 50 and base unit 48 are preferably coated with a mixture of gelatin, Xanthan and alum, a mixture often used to coat ordinary playing cards. The coating is preferably non-toxic and provides resistance to liquids so that the test device does not decompose when exposed to the liquid specimen. In this manner, the entire tester can be incinerated without producing toxic gasses. In some embodiments, the inside of the cover 50 and base unit 48 are also coated with the same coating (not shown).

In some embodiments, the test strips 53 comprise a hydrophilic microporous membrane that is treated with an agent that reacts to the presence of specific matter in the test specimen by changing color. For example, a test wick 53 is treated with an agent that changes color upon exposure to b-hCG, thereby when exposed to a urine sample containing b-hCG (e.g., from a pregnant woman), that specific test strip changes color. Many test strips are known in the industry and the present invention is not limited to any particular test strip, chemical compound or test strip construction. For an example, several test strips are disclosed in U.S. Pat. No. 6,150,178 to Cesarczyk and Phildius. In some embodiments, the test strips 15 include a filter layer and a drying layer, as known in the industry.

In some embodiments, an identification label 38 is provided on an outside surface of the base unit 48. The identification label 38 lets the technician write notes on the base unit 48. In some embodiments, the identification label 38 is a peel-off label having a permanent portion 30 that adheres to the base unit 48 and a removable portion 38 that can be removed and, for example, affixed to a patient's medical chart or record. The removable portion 38 preferably has an adhesive backing to stick to the patient's medical chart or record. In some embodiments, the permanent portion 30 is treated with a carbonless copy coating so that writing on the removable label 38 transfers onto the permanent label 30. In some embodiments, a serial number or similar code 39 is printed on the removable label 38 and a matching code 36 is printed on the base unit 48 to enable matching of the removable label 38 to the base unit 48 after they are separated. In this example, the serial number 36/39 is a series of numerical digits while in other embodiments, the serial number 36/39 is alphanumeric or a bar code or other matching system.

The embodiments shown are only examples of many different tester form factors that can be conceived without veering from the present invention. Many different sizes, shapes and security mechanisms are possible, all made from the same basic paper substrate and coated with a biodegradable water resistant coating.

Equivalent elements can be substituted for the ones set forth above such that they perform in substantially same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An disposable apparatus for collecting and testing a specimen, the apparatus comprising:
an enclosure made from a stiff paper, the stiff paper coated on at least one side with a water resistant coating; and
at least one test strip interfaced to the enclosure.

2. The disposable apparatus for collecting and testing a specimen of claim 1, whereas the enclosure has a sample window and an indicator window for each of the at least one test strips and each of the least one test strips is affixed inside the enclosure situated so that the at least one test strip accepts a sample at the sample window and indicates at the indicator window.

3. The disposable apparatus for collecting and testing a specimen of claim 1, wherein the stiff paper is 450 g white cardboard.

4. The disposable apparatus for collecting and testing a specimen of claim 1, wherein the water resistant coating is made from a mixture of mixture of gelatin, Xanthan and alum.

5. The disposable apparatus for collecting and testing a specimen of claim 1, further comprising a peel-able label affixed to an outside surface of the enclosure.

6. The disposable apparatus for collecting and testing a specimen of claim 5, wherein the peel-able label has an identification code.

7. The disposable apparatus for collecting and testing a specimen of claim 6, wherein the enclosure has a matching identification code matching the pee-able label identification code.

8. The disposable apparatus for collecting and testing a specimen of claim 5, wherein the peel-able is removably affixed to a permanent label and the permanent label is treated with a carbonless copy coating whereby writing on the peel-able label transfers to the permanent label.

9. A method for collecting and testing a specimen using a disposable tester, the method comprising:
providing a tester, the tester comprising:
an enclosure made from a stiff paper, the stiff paper coated with a water resistant coating; and
at least one test strip interfaced to the enclosure;
exposing the at least one test membrane at an exposure point to the specimen;
reading the results from an indicator window.

10. The method for collecting and testing a specimen using a disposable tester of claim 9, whereas the enclosure has a sample window and an indicator window for each of the at least one test strips and each of the least one test strips is affixed inside the enclosure situated so that the at least one test strip accepts a sample at the sample window and indicates at the indicator window.

11. The method for collecting and testing a specimen using a disposable tester of claim 9, wherein the stiff paper is 450 g white cardboard.

12. The method for collecting and testing a specimen using a disposable tester of claim 9, wherein the water resistant coating is made from a mixture of mixture of gelatin, Xanthan and alum.

13. The method for collecting and testing a specimen using a disposable tester of claim 9, wherein the tester further comprises a peel-able label affixed to an outside surface of the enclosure.

14. The method for collecting and testing a specimen using a disposable tester of claim 13, wherein the peel-able label has an identification code.

15. The method for collecting and testing a specimen using a disposable tester of claim 14, wherein the enclosure has a matching identification code matching the pee-able label identification code.

16. The method for collecting and testing a specimen using a disposable tester of claim 13, wherein the peel-able is removably affixed to a permanent label and the permanent label is treated with a carbonless copy coating whereby writing on the peel-able label transfers to the permanent label.

17. An disposable apparatus for collecting and testing a specimen, the apparatus comprising:
an enclosure means made from a paper means, the enclosure means coated with a water resistant coating; and
at least one test strip means interfaced to the enclosure means.

18. The disposable apparatus for collecting and testing a specimen of claim 17, whereas the enclosure means has a sample window and at least one indicator window for each of the at least one test strip means and each of the least one test strip means is affixed inside the enclosure means situated so that the at least one test strip means accepts a sample at the sample window and indicates a result at the indicator window.

19. The disposable apparatus for collecting and testing a specimen of claim 17, wherein the paper means is 450g white cardboard.

20. The disposable apparatus for collecting and testing a specimen of claim 17, wherein the water resistant coating is made from a mixture of mixture of gelatin, Xanthan and alum.

21. The disposable apparatus for collecting and testing a specimen of claim 17, further comprising a peel-able label means affixed to an outside surface of the enclosure means.

22. The disposable apparatus for collecting and testing a specimen of claim 17, wherein the enclosure means and the test strip means are made from the same substrate material.
